(19) United States
(12) Patent Application Publication
(10) Pub. No.: US 2009/0194634 A1
(43) Pub. Date: Aug. 6, 2009

(54) UNMANNED VEHICLE HAVING A CAMOUFLAGE APPARATUS

(75) Inventor: Norbert Stelte, Uberlingen (DE)

Correspondence Address: LERNER GREENBERG STEMER LLP, P O BOX 2480, HOLLYWOOD, FL, 33022-2480, US

(73) Assignee: DIEHL BGT DEFENCE GMBH & CO. KG, Uberlingen (DE)

(21) Appl. No.: 12/363,982

(22) Filed: Feb. 2, 2009

(30) Foreign Application Priority Data
Feb. 1, 2008 (DE) 10 2008 007 208.7

(51) Int. Cl. B63G 13/02

(52) U.S. Cl. 244/1 R

(57) ABSTRACT

An unmanned vehicle has a camouflage apparatus which simulates a characteristic of an animal. This allows effective camouflage to be achieved despite the unmanned vehicle being clearly visible.

### CROSS-REFERENCE TO RELATED APPLICATION

This application claims the priority, under 35 U.S.C. §119, of German application DE 10 2008 007 208.7, filed Feb. 1, 2008; the prior application is herewith incorporated by reference in its entirety.

### BACKGROUND OF THE INVENTION

### Field of the Invention

An unmanned vehicle, such as an unmanned aircraft or watercraft, in particular an underwater vehicle, can be used for reconnaissance, warning and monitoring. An unmanned vehicle may be equipped with sensors, for example imaging sensors, for tasks such as these. Other active systems, such as jamming systems, are also feasible.

In some situations, the target of an operation with an unmanned vehicle may have an interest in frustrating the purpose associated with their use, or at least in becoming aware of the purpose. The most obvious defensive measure is to identify the unmanned vehicle. Various sensors, preferably imaging sensors, may be used in order to identify an unmanned vehicle. In order to conceal a vehicle from such sensors, it is known for unmanned vehicles to be made as difficult to see or to identify as possible, by means of a camouflage apparatus.

### SUMMARY OF THE INVENTION

It is accordingly an object of the invention to provide an unmanned vehicle with a camouflage apparatus, which overcomes the disadvantages of the heretofore-known devices and methods of this general type and which is improved and provides for an effective camouflage apparatus.

With the foregoing and other objects in view there is provided, in accordance with the invention, an unmanned vehicle with a camouflage apparatus that is configured to simulate a characteristic of an animal.

In other words, the objects of the invention are achieved by an unmanned vehicle of the type mentioned initially in which the camouflage apparatus, according to the invention, simulates a characteristic of an animal. This allows effective camouflage to be achieved despite it being possible to see the unmanned vehicle clearly.

The invention is in this case based on the idea that one difficulty in identification of an unmanned vehicle is to distinguish it from other objects. In the case of air space that is to be monitored these are other aircraft and hovering objects, such as commercial aircraft, helicopters and weather balloons a long distance away, as well as animals such as birds, bats and large insects. When a water surface or an underwater area is intended to be monitored, these may be watercraft a long distance away as well as animals such as birds and fish. A distinction is drawn between an unmanned vehicle and an animal by means of features which distinguish an animal from a known unmanned vehicle. If a vehicle is provided with a distinguishing animal feature, a distinguishing process directed at this will fail.

The unmanned vehicle may be an aircraft, a watercraft or an underwater vehicle. The camouflage apparatus may simulate an optical characteristic, and in particular an acoustic and/or behavioral characteristic is advantageous, which is expediently a movement characteristic.

In one advantageous embodiment of the invention, the vehicle comprises a drive unit which is concealed by the camouflage apparatus, at least at the front and at the sides. Since a drive unit represents a considerable distinguishing feature between a vehicle and an animal, concealing the drive unit can lead to considerable visual camouflage and in addition to screening of noise by means of which discrimination would otherwise be possible.

If the vehicle has a plurality of drive units, then it is advantageous for the camouflage apparatus to conceal the drive units by simulations of various animal body parts, for example by simulations of a wing or of a rear part of a bird. In particular, this also allows more than two relatively large-volume drive units to be camouflaged such that they are inconspicuous.

Unmanned vehicles are used only individually, in particular for reconnaissance in the air or in the water. Very reliable discrimination is therefore discrimination which distinguishes a single object from a plurality of objects of the same type. This distinguishing process can be confused if the vehicle has a plurality of identical elements which are separated from one another and in their totality simulate a group of animals. Each element may thus in its own right simulate an animal, with the animal simulations expediently being at least essentially identical.

Advantageously, the elements are each connected by means of at least one connection means to at least one of the other elements, and the connection means each make up at most 1/10 of the visible area of an element. This allows the elements to be held together in an inconspicuous manner. The visible area is advantageously seen from a viewing direction from the front and/or from underneath of the vehicle, with the connection means each expediently making up only at most 1/10 of the visible area of an element, from all viewing directions.

If the elements comprise peripheral elements and a central element, with the peripheral elements each surrounding a drive unit and with the central element surrounding a control unit, then the vehicle can be moved in a particularly stable manner in flight, and in particular can be kept in a hovering state well.

In one advantageous development of the invention, the camouflage apparatus simulates a bird, and has wing elements which are intended to flap. This makes it possible to achieve a movement which is typical of birds, but is atypical of unmanned aircraft, and which is difficult to distinguish from a bird.

The wing elements are expediently prepared to form a flapping drive by means of air drag. This means that there is no need for a drive for the wing elements, and the aircraft can be kept simple.

The wing elements are advantageously provided in addition to wings. It is possible to distinguish between flight-stabilizing and supporting characteristics of the wings and camouflage characteristics of the wing elements, thus making it possible to achieve stable flying characteristics for the aircraft.

In order as far as possible to visually conceal fixed wings in the presence of flapping wing elements, the wing elements are advantageously designed to be visually more conspicuous than the wings.

A camouflage characteristic other than just a visual camouflage characteristic can be achieved by a control means which is intended to carry out a movement non-uniformly, and to simulate an animal movement. The distinguishing criterion of the uniform movement can be overcome and the vehicle can be effectively camouflaged.

The movement is expediently a forward movement, such as flight or a fish gliding underwater.

The control means is advantageously intended to control a plurality of different movements modes, in particular flight modes, alternately, expediently arhythmically. A typical animal movement can be simulated in a very similar form, achieving a far-reaching camouflage. If the control means is intended to control climbing flight and flight which at least simulates gliding flight, then a particularly animal-like sequence of movements can be achieved, which is difficult to identify as being simulated.

A further improvement in the camouflage can be achieved by wing elements which are intended to flap, with the control means being intended to control a movement of the wing elements during climbing flight and a stationary position of the wing elements during gliding flight.

Camouflage which is directed at a distinguishing feature which is not visual can be achieved by a control means which is intended to operate a drive unit such that the drive unit transmits non-uniform noise. An identification apparatus which is sensitive to normal uniform vehicle noise can be overcome.

Additional acoustic camouflage can be achieved by the camouflage apparatus comprising a noisemaker for transmission of an animal-specific noise.

Further advantages will become evident from the following drawing description. The drawing illustrates exemplary embodiments of the invention. The drawing and the description contain numerous features in combination, which a person skilled in the art will expediently also consider individually and combine to form further worthwhile combinations.

Other features which are considered as characteristic for the invention are set forth in the appended claims.

Although the invention is illustrated and described herein as embodied in unmanned vehicle having a camouflage apparatus, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic view from underneath, of an unmanned aircraft with bird camouflage;

FIG. 2 is a silhouette view from the front of the aircraft; and

FIG. 3 is a schematic view of an aircraft camouflaged as a flock of birds.

### DETAILED DESCRIPTION OF THE INVENTION

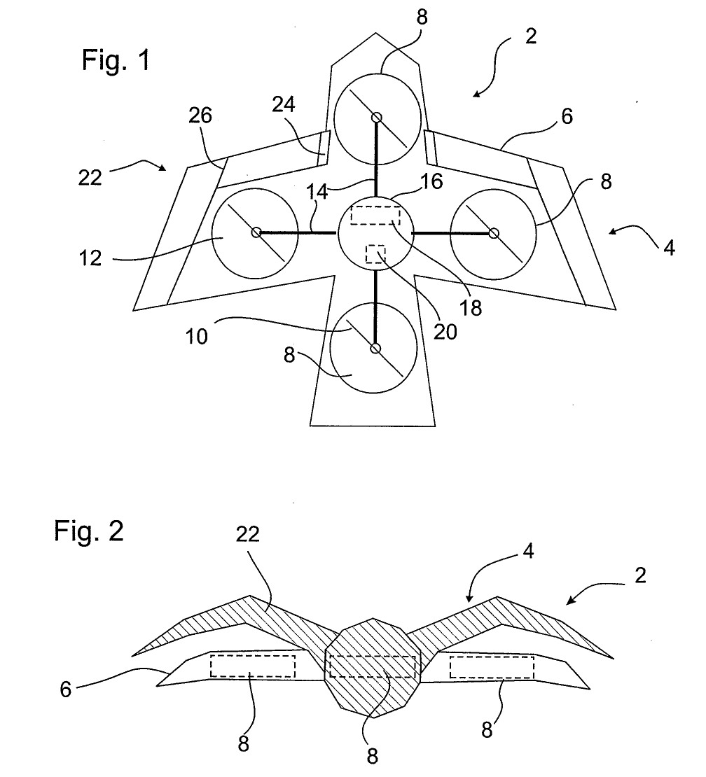

Referring now to the figures of the drawing in detail and first, particularly, to FIG. 1 thereof, there is shown an unmanned vehicle 2 in the form of an aircraft, illustrated from underneath, which has a camouflage apparatus 4 with an outer casing 6 in the form of a large bird, for example a bird of prey. In a simpler embodiment, the shape can be stylized such that at least one silhouette of the bird is simulated. FIG. 2 illustrates a silhouette of the aircraft from the front. The aircraft is equipped with four drive units 8, which each have a rotor 10 in a tubular opening 12 in the outer casing 6. All of the drive units 8, in particular their rotors 10, are concealed at the front, at the rear and on both sides by the outer casing 6, and can be seen only from above and from underneath, with the front drive unit 8 being concealed in a simulation of a bird's head, the rear drive unit 8 being concealed in a simulation of a bird's tail, and with the two side drive units 8 each being concealed in a simulation of a bird's wings. The outer casing 6 is composed of plastic, which is opaque in visual and infrared light. The claddings on the openings 12 are provided with radar screening, for example by means of an appropriate coating. Other parts of the aircraft can also be camouflaged in a corresponding manner.

The drive units 8 form outer elements which are rigidly connected by four connection means 14 in the form of rods to a central element 16 which, in addition to reconnaissance sensors that are not illustrated, conceals a control unit or control means 18 and a noisemaker 20. The control means 18 is used to control all the functions of the aircraft.

In order to simulate bird wings, the aircraft in each case has wing elements 22, which wing elements 22 are intended to flap and can be moved upwards and downwards by means of a drive, which is not illustrated, and a joint 24. In a simpler embodiment, the wing elements 22 can be moved without a drive and may be provided with a shape and mobility such that they are caused to flap by the airflow. The wing elements 22 are designed to be visually more conspicuous than the rigid simulations of the bird wings, for example by appropriate coloring and/or patterning, such that the wing elements 22 clearly dominate the visual impression of the aircraft during flapping. The more conspicuous coloring is indicated in FIG. 2 by shading of the wing elements 22 and of the fuselage. FIG. 2 illustrates the wing elements 22 during an upward movement. An intermediate joint 26 makes it possible, for example, to select straighter wing positions for downward wing flapping.

The movement of the wing elements 22 which move with respect to the wing simulations is controlled by the control means 18 such that different movement modes alternate irregularly. For this purpose, the control means 18 is provided with a control programme which controls a movement sequence, simulating an animal movement, with different movement modes. The movement modes are coupled to the control of the drive units 8, in such a way that movement modes of the wing elements 22 are linked to associated flight modes of the drive units 8.

In a first movement mode, the wing elements 22 flap in a fast mode, for example 4 Hz, with the control means 18 controlling the drive units 8 such that the aircraft flies in climbing flight. In a second movement mode, the wing elements 22 are stationary in a position which wings of a bird assume when gliding, with the drive units 8 being controlled to create slightly descending flight, which visually simulates the gliding of a bird. The third movement mode comprises slow flapping of the wing elements 22, for example at 3 Hz, and the drive units 8 being controlled for flight at a uniform altitude and speed.

The control means 18 is also prepared to operate the drive units 8 such that they transmit non-uniform noise. This can be done by varying the rotation speed of the rotors 10, expediently with simultaneous adjustment of the blade pitch of the rotor blades of the rotors 10, such that the same lift and/or forward drive are or is achieved with a fluctuating rotation speed. The rotor blades can also be adjusted in such a way that their air drag is varied such that they transmit a varying noise. The variation of the noise can be coupled to the movement and/or movement modes of the wing elements 22, for example to the frequency of the wing beating, or, for example, may simulate random frequency noise. For further camouflage, the noisemaker 22 may transmit an animal-specific noise, for example the call of a swan, or the call of geese.

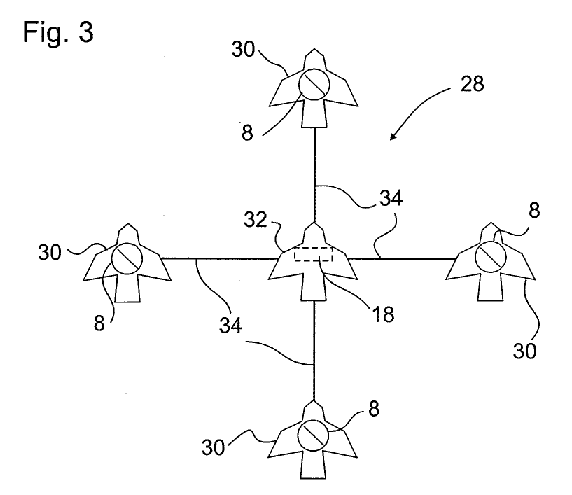

FIG. 3 shows a vehicle 28 camouflaged as a flock of birds. The following description is essentially restricted to the differences from the exemplary embodiment in FIGS. 1 and 2, to which reference is made with regard to features and functions which remain the same. Components which essentially remain the same are in principle annotated with the same reference symbols.

The vehicle 28 comprises a plurality of identical elements 30, 32 which are separated from one another and in their totality simulate the group of animals. Each of the elements 30, 32 simulates one animal and is for this purpose provided with an appropriate outer casing. Outer elements 30 are each connected by a connection means 34 to an inner element 32. In the exemplary implementation, the connection means 34 are rigid rods, which are held such that they are visually inconspicuous and, for example, have camouflage paint applied to them. In their totality, they each make up less than 1/10 of the visible area of an element 30, 32 from any direction.

The outer elements 30 each support drive units 8 and the inner element 32 supports a control means 18, with respect to whose functions reference is made to the description relating to FIGS. 1 and 2. The elements 30, 32 are each connected to one another such that they can adjust their relative position with respect to one another. For this purpose, the elements 30, 32 are each connected, for example in a central connection area, via joints which are not illustrated to the connection means 34, such that they can be banked laterally during turning flight, without having to bank the vehicle 28 in its entirety. The connection area is expediently located on the top of the elements 30, 32, in such a way that the joints cannot be seen from underneath.

1. An unmanned vehicle, comprising a camouflage apparatus configured to simulate a characteristic of an animal.

2. The vehicle according to claim 1, which further comprises a drive unit concealed by said camouflage apparatus, at least at a front of the vehicle and at the sides thereof.

3. The vehicle according to claim 1, which comprises a plurality of drive units 8, said camouflage apparatus concealing said drive units with simulations of different animal body parts.

4. The vehicle according to claim 1, which comprises a plurality of substantially identical elements, separated from one another, and in a totality thereof simulating a group of animals.

5. The vehicle according to claim 4, wherein each one of said elements is connected to at least one other one of said elements via a connection means, and said connection means each make up at most one tenth of a visible area of a respective element.

6. The vehicle according to claim 4, wherein said elements include peripheral elements and a central element, said peripheral elements each containing a drive unit and said central element containing a control unit.

7. The vehicle according to claim 1, wherein said camouflage apparatus simulates a bird and said apparatus includes wing elements configured to flap.

8. The vehicle according to claim 7, wherein said wing elements are configured to form a flapping drive by means of air drag acting thereupon.

9. The vehicle according to claim 7, wherein said wing elements are provided in addition to wings.

10. The vehicle according to claim 9, wherein said wing elements are designed to be visually more conspicuous than said wings.

11. The vehicle according to claim 1, which comprises a control unit configured to carry out non-uniform motion, and to simulate an animal movement.

12. The vehicle according to claim 11, wherein said control unit is configured to control a plurality of different movement modes alternately.

13. The vehicle according to claim 12, wherein said control unit is configured to control the plurality of different movement modes arhythmically.

14. The vehicle according to claim 11, wherein said control unit is configured to simulate a climbing flight pattern and to simulate a gliding flight pattern.

15. The vehicle according to claim 14, which comprises wing elements configured to flap, and wherein said control unit controls a movement of said wing elements during climbing flight and maintains a stationary position of said wing elements during gliding flight.

16. The vehicle according to claim 1, which comprises a control unit configured to operate a drive unit to transmit non-uniform noise.

17. The vehicle according to claim 1, wherein said camouflage apparatus comprises a noisemaker for generating an animal-specific noise.
